(19) United States
(12) Patent Application Publication
(10) Pub. No.: US 2009/0214056 A1
(43) Pub. Date: Aug. 27, 2009

(54) Sound quality adjustment device

(76) Inventor: Koji Takahata, Kyoto (JP)

Correspondence Address: SUGHRUE MION, PLLC, 2100 PENNSYLVANIA AVENUE, N.W., SUITE 800, WASHINGTON, DC, 20037, US

(21) Appl. No.: 11/547,394

(22) PCT Filed: Dec. 20, 2004
(86) PCT No.: PCT/JP04/19023

§ 371 Date: Oct. 27, 2008

(30) Foreign Application Priority Data
Mar. 29, 2004 (JP) 2004-095249

(51) Int. Cl. H04B 15/00

(52) U.S. Cl. 381/94.5

(57) ABSTRACT

A sound signal switchover means capable of preventing pop noise sound in an audio system from being generated is down-sized, and a time constant of a time constant unit for the changeover of the sound signals can be varied, thereby enabling the switchover to be implemented with greater smoothness. A sound signal selection means (12) having a plurality of switches (SW 1a′ to SW 2b′) for switching over the sound signal to the sound signal having the different output level is provided between a sound input source, and a sound output means. When switching over the sound signal to the sound signal having the different output level, the sound signals before and after the switchover coexist and the switchover is implemented at that point in time. A time constant unit (8) is made up of a SCF built in an IC, and the time constant τ can be controlled to be freely adjusted by a clock signal Fclk obtained by dividing a reference signal generated in a VCO (6) by a variable frequency dividing rate.

### TECHNICAL FIELD

The invention relates to an audio system, and in particular, to an audio system such as an electronic volume, and so forth, for electronically switching over between output levels of a sound signal.

### BACKGROUND TECHNOLOGY

There have lately been in general use an audio system called an electronic volume, comprising a circuit for electronically switching over between output levels of an inputted sound signal before outputting, an audio system such as a graphic equalizer and sound effects, comprising a circuit for electronically changing gains of sound signals in respective bands before outputting, and so forth.

With such audio systems as described, there are cases where a selected sound signal undergoes an abrupt change in level at the time of an electronic switchover between switching circuits that are used in an electronic volume circuit, a gain control circuit, and so forth, thereby causing a peculiar sound, such as a pop noise sound, and so forth, to be generated from a speaker, or causing a user to have an uncomfortable feeling as if a sudden interruption has occurred to a sound.

FIG. 6 is a view showing an example of such a case showing a state where an output voltage as outputted is discontinuous at a time t1 when the switching circuit is switched. More specifically, FIG. 6A is a view showing a case where a voltage level of a signal whose DC voltage level ought to be constant has come to vary due to an offset voltage (ΔV), and so forth, and FIG. 6B is a view showing a case where the signal has undergone a change in phase.

In order to prevent occurrence of those problems, for example, in Patent Document 1, there is disclosed a case where detection is made on a point in time (hereinafter referred to as a zero-cross point) when an input signal as inputted to the electronic volume circuit becomes equal to a reference voltage, as shown in a waveform chart of FIG. 7, and a sound signal is switched at the zero-cross point, thereby effecting switchover of the signal when a signal level is identical. In FIG. 7, a waveform in the upper part indicates a relationship between the input signal and the reference voltage while a waveform in the lower part indicates an output signal that is outputted corresponding to the detection of the zero-cross point. If the switching circuit is switched over with the use of the output signal described, even when the sound signal varying in voltage level is outputted, it follows that switchover takes place when the input signal is identical in voltage level to the reference voltage, so that it is possible to prevent occurrence of an abrupt change in an output voltage level.

Further, as shown in FIG. 8, in Patent Document 2, there is disclosed an audio system capable of easily preventing sound giving an uncomfortable feeling from being outputted by a sound outputting means even in the case of switching over between sound signal propagation paths, and the audio system comprises a sound input source 11 for reproducing and amplifying a sound signal recorded in a storage medium such as a magnetic tape, or an optical disk, and so forth, and amplifying a sound signal from a microphone, and so forth, a sound output means 14 such as a speaker, and so forth, a sound signal selection means 12 provided between the sound input source 11, and the sound output means 14, for switching over between the sound signal propagation paths provided therebetween, on the basis of a control signal from a system controller 15, and an output amplifier 13.

As shown in FIG. 9, the sound signal selection means 12 of the audio system comprises a plurality of switching circuits SW 1 (a, b, c, d), SW 2 (a, b, c, d), provided so as to correspond to a plurality of sound signals, respectively, and a signal switching circuit 3 for causing the switching circuit corresponding to the sound signal to be selected to turn ON, thereby gradually attenuating the sound signal from the switching circuit selected prior to switchover while gradually increasing magnitude of the sound signal from the switching circuit to be selected after the switchover.

In the audio system shown in FIG. 9, an electronic volume circuit 12, as a specific example of the sound signal selection means, comprises an input terminal IN for receiving the sound signal from the sound input source 11, an output terminal OUT for outputting the sound signal to the output amplifier 13, a plurality of resistors R1 to R4, series-connected between the input terminal IN, and a reference potential, for generating divided voltages of the sound signal, respectively, an amplifier 1 having an input to which the input terminal IN, and signals at respective voltages, subjected to resistance voltage division, are connected in common via the switching circuits SW 1 (a, b, c, d), respectively, an amplifier 2 having an input to which signals identical in voltage level to those connected to the switching circuits SW 1 (a, b, c, d) are connected in common via the switching circuits SW 2 (a, b, c, d), respectively, a signal switching circuit 3 for outputting a sound signal to the output terminal OUT while gradually altering a ratio of amplification by the amplifier 1 to that by the amplifier 2, and a controller 4 for controlling selection of the respective switching circuits, and the ratios of amplification by the respective amplifiers, respectively, corresponding to setting data from the system controller 15.

While a serial data signal SD, a serial clock signal SCK, and a data latch signal DL are inputted from the system controller 15 to the controller 4, the controller 4 outputs control signals SWC 1, SWC 2, for controlling the respective switching circuits, and a control signal SWC 3 for controlling the signal switching circuit 3. Further, respective inverting input terminals of the amplifier 1 and the amplifier 2 are connected to outputs of the respective amplifiers.

Now, based on a timing chart of FIG. 10, there is described hereinafter an operation when a sound volume level is changed over from a voltage level at the input terminal IN to a level of a voltage generated at a node between the resistors R1, R2. The setting data consisting of 8 bits, such as a volume, and so forth, sent from the system controller 15, is read into the controller 4 at predetermined timing by the serial data signal SD, and the serial clock signal SCK to be subsequently latched at the timing of the data latch signal DL, thereby completing setting of the electronic volume circuit 12 as the sound signal selection means. The controller 4 first turns the switching circuit (SW 2b) to be next selected ON according to the setting data, and turns the switching circuit (SW 1a) presently selected OFF after the elapse of predetermined time (tch) while in the meantime, the signal switching circuit 3 gradually switches from an output of the amplifier 1 presently selected to an output of the amplifier 2 to be next selected. That is, both the amplifiers 1, 2 are operated during the predetermined time (tch), and at the same time, a ratio of a sound signal outputted from the amplifier 1 among respective sound signals inputted to the signal switching circuit 3 according to the control signal SWC 3 is gradually decreased while a ratio of a sound signal outputted from the amplifier 2 is gradually increased, thereby outputting a composite signal thus generated from the output terminal OUT.

Similarly, when switchover is made from a signal level selected by the switching circuit SW 2b to the next signal level, any of the switching circuits SW 1 (a, b, c, d), to be next selected, is first turned ON, and after the elapse of the predetermined time (tch), the switching circuit SW 2b is turned OFF. In the meantime, the signal switching circuit 3 gradually switches over from the output of the amplifier 2 presently selected to the output of the amplifier 1 to be next selected. Such an operation as described is repeated, thereby implementing switchover to an optional signal level.

In other words, with the signal switching circuit 3, while respective values of current flowing to respective constant current sources (not shown) are controlled corresponding to the control signal SWC 3 so as to control amplification factors of the respective amplifiers, outputs of the respective amplifiers are added up, thereby selecting respective input signals from input terminals a, b, respectively, at an optional ratio to be then outputted from the output terminal OUT. Because such a switching operation is gradually executed at intervals over time of from several tens to several hundreds of ms, preferably from 100 to 200 ms, even if the input signals as inputted to the respective input terminals differ in voltage level from each other, a level of an outputted voltage will not undergo an abrupt change. Consequently, sound irritating in terms of the sense of hearing is prevented from being outputted from the speaker, and so forth.

With a method of switching the sound signal at the zero-cross point in the audio system, as disclosed in Patent Document 1, however, as indicated by part of waveform of an input signal, in the vicinity of the zero-cross point, shown in FIG. 11, there occurs delay indicated by “td” from detection of the zero-cross point at time t2 to actuation of the switching circuit, thereby causing an actual switchover of the input signal, so that there results variation in output voltage level (VIN 1, VIN 2) depending on a signal waveform of the input signal (IN 1, IN 2) inputted at that point in time. In other words, it is not a case where any of input signals can be switched over at a fully identical voltage, so that it has been difficult to completely eliminate an uncomfortable feeling in terms of the sense of hearing. Further, there has been a problem in that this method is not applicable to input signals differing in phase from each other.

Further, even in the case of switchover between signals that ought to be at an identical voltage level, it has been extremely difficult to cause voltage levels that are to be switched over to coincide with each other all the time by completely eliminating an offset voltage occurring to circuits.

With the audio system described in Patent Document 2, the above-described problems encountered by the audio system described in Patent Document 1 do not occur, however, a sound signal level changing means of the audio system described in Patent Document 2 has a problem in that not only a considerable increase in circuit scale (the number of switches and, so forth) results, but also a time constant unit for setting switching time needs a capacitor large in capacitance, rendering it impossible to assemble a capacitor CX within an IC, so that the capacitor CX need be installed externally as shown in FIG. 9. Further, there is another problem in that a time constant is unchanged unless capacitance and a resistance value of the time constant unit using an externally installed capacitor, and the time constant cannot be changed once the time constant unit is formed.

### [Patent Document 1] JP 3-48507 A

### [Patent Document 2] JP 11-340759 A

### DISCLOSURE OF THE INVENTION

### Problem to be Solved by the Invention

The invention has been developed in order to resolve those problems encountered in the past as described in the foregoing, and it is an object of the invention to change a time constant while down-sizing circuits, thereby enabling a sound signal level to be changed with greater smoothness.

### Means for Solving Problem

The invention disclosed in Claim 1 is an audio system comprising a sound input source including a microphone, and so forth, a sound output means including a speaker, and so forth, a sound signal selection means provided between the sound input source, and the sound output means, for switching over between sound signal propagation paths provided therebetween, on the basis of a control signal from a control means, said sound signal selection means comprising a plurality of switching circuits provided so as to correspond to a plurality of sound signal output levels, respectively, and a signal switching circuit switchover means for turning ON the switching circuit corresponding to the sound signal output level to be selected on the basis of the control signal, wherein at the time of switchover of respective sound signal, the signal switching circuit switchover means concurrently turns ON the switching circuit selected prior to the switchover, and the switching circuit to be selected after the switchover, and at the same time, gradually reducing a sound signal from the switching circuit selected prior to the switchover within time specified by a time constant of a time constant unit assembled inside an IC while gradually increasing a sound signal from the switching circuit to be selected after the switchover.

The invention disclosed in Claim 2 is the audio system in Claim 1, wherein the time constant unit is made up of a switched capacitor filter circuit.

The invention disclosed in Claim 3 is the audio system in Claim 1 or 2, further comprising a means for feeding a clock signal for controlling the time constant of the switched capacitor filter circuit, and a means for controlling a frequency of the clock signal.

The invention disclosed in Claim 4 is the audio system in Claim 3, wherein the means for controlling the frequency of the clock signal is a controller for controlling a frequency dividing rate of a reference signal generated by a voltage-controlled oscillator.

### EFFECT OF THE INVENTION

With the adoption of a configuration of the audio system according to the invention, it becomes possible to prevent the sound signal as selected from being abruptly switched over from a first signal level to a second signal level, so that there is obtained an advantageous effect that sound causing an uncomfortable feeling can be easily prevented from being outputted from the sound output means.

In particular, since the invention has succeeded in reduction of externally installed components such as a capacitor, and so forth, and in rendering the time constant variable, space-saving, and higher performance have been implemented. This has enabled development of products more adaptable to user's needs.

Furthermore, by creating resistance large in resistance value R inside the IC, the capacitor of the time constant unit can be rendered smaller in capacitance, so that the capacitor can be assembled inside the IC, thereby enabling the circuit to be down-sized and cost of the system to be reduced.

### BRIEF DESCRIPTION OF THE DRAWINGS

FIG. 1 is a block diagram broadly showing one embodiment of a sound signal selection means (an electronic volume circuit as a constituent of an audio system) according to the invention;

FIG. 2 is a block diagram specifically showing parts of the sound signal selection means shown in FIG. 1;

FIG. 3 is a view for illustrating a time constant unit for use in the sound signal selection means shown in FIG. 1, or FIG. 2, in which FIG. 3A shows a time constant circuit using an SCF, FIG. 3B shows an equivalent circuit of the time constant circuit, and FIG. 3C shows signals for controlling opening/closing of respective switches of the SCF;

FIG. 4 is a waveform chart showing sound signal switchover states;

FIG. 5 is a time chart for illustrating switchover of sound signals;

FIG. 6 is a view showing a switchover state of sound signals according to a conventional audio system;

FIG. 7 is a view showing a switchover state of sound signals according to another conventional audio system;

FIG. 8 is a block diagram broadly showing the conventional audio system;

FIG. 9 is a block diagram broadly showing a conventional sound signal selection means (a conventional electronic volume circuit);

FIG. 10 is an operation timing chart for illustrating an operation of the conventional sound signal selection means;

FIG. 11 is a waveform chart showing sound signal switchover states in the conventional audio system.

### EXPLANATION OF LETTERS OR NUMERALS

1,2 . . . amplifier, 3 . . . signal switching circuit, 4,4a . . . controller, 5 . . . frequency divider, 6 . . . VCO, 7 . . . microcomputer, 8 . . . time constant unit, 9 . . . signal switching circuit, 10 . . . audio system, 11 . . . sound input source, 12 . . . electronic volume unit (sound signal selection means), 13 . . . output amplifier, 14 . . . speaker (sound output means), 15 . . . system controller (control means), SW1a′,SW1b′,SW2a′,SW2b′ . . . switching circuit

### BEST MODE FOR CARRYING OUT THE INVENTION

One embodiment of an audio system according to the invention is described hereinafter with reference to the accompanying drawings.

As with the conventional audio system shown in FIG. 8, an audio system 10 is provided between a sound input source 11, such as a microphone, and so forth, and a sound output means 14, such as a speaker, and so forth, and the audio system 10 comprises an electronic volume unit 12 serving as a sound signal selection means for switching over between sound signal propagation paths between the sound input source, and the sound output means, on the basis of a control signal from a system controller 15, and an output amplifier 13.

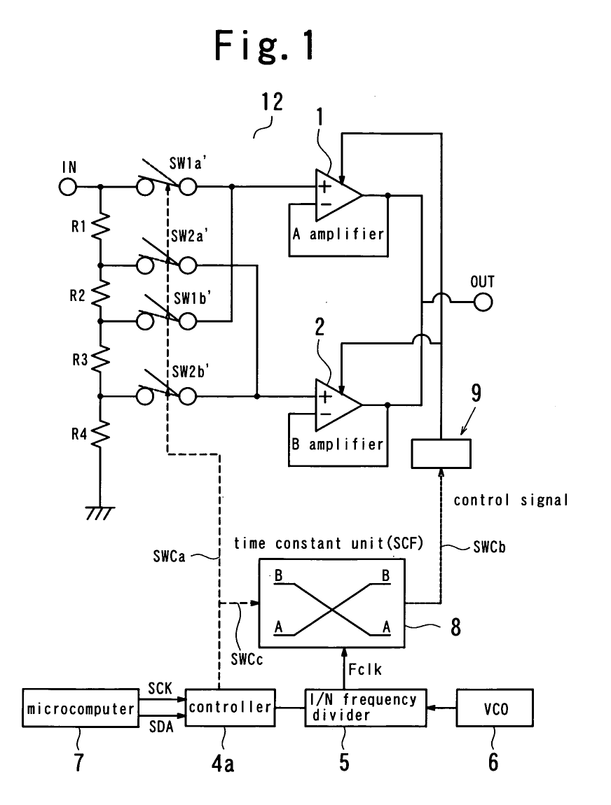

FIG. 1 is a block diagram broadly showing one embodiment of the electronic volume unit as a constituent of the audio system according to the invention. The electronic volume unit 12 according to the present embodiment comprises an input terminal IN for receiving a sound signal from the sound input source 11, an output terminal OUT for outputting a sound signal to the output amplifier 13, a plurality of resistors R1 to R4, series-connected between the input terminal IN, and a reference potential, for generating divided voltages of the sound signal, respectively, switching circuits SW 1a′ to SW 2b′, for inputting signals at respective levels of the voltages divided by the input terminal IN, and the resistors R1 to R4, respectively, to an input terminal of the conventional amplifier 1, or the conventional amplifier 2, a signal switching circuit 9 for controlling the amplifier 1, and the amplifier 2 upon receiving a control signal from a time constant unit 8 to be described later in order to output a sound signal to the output terminal OUT while gradually altering a ratio of amplification by the amplifier 1 to that by the amplifier 2, a controller 4a for selecting the respective switching circuits SW 1a′ to SW 2b′ according to setting data from a microcomputer 7, a frequency divider 5 for dividing a frequency of a reference signal generated by a VCO (voltage-controlled oscillator) 6 to 1/N according to a command from the controller 4a, on a frequency dividing rate, and the time constant unit 8 for controlling switching time of each of the amplifiers 1, 2, based on a system clock frequency Fclk as divided. The time constant unit 8 is made up of an SCF (Switched Capacitor Filter) to be described later, and is assembled inside an IC.

The controller 4a receives a serial clock SCK, and a serial data signal SDA from the microcomputer 7, and outputs a control signal SWCa for the respective switching circuits, and a signal SWCc corresponding to ON/OFF of respective switches to the time constant unit 8.

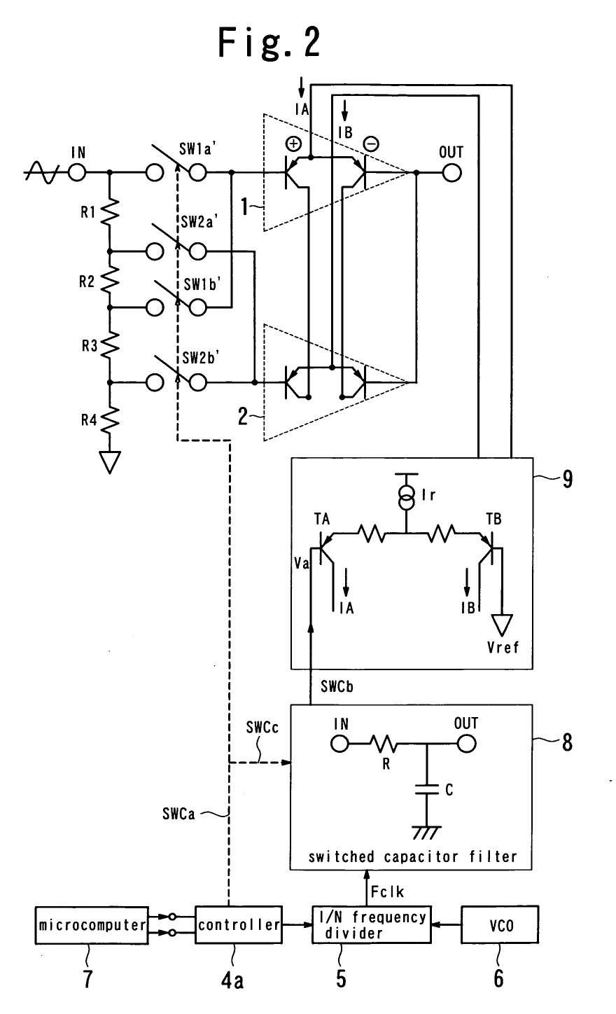

FIG. 2 is a circuit diagram specifically showing respective elements shown in the block diagram of FIG. 1. As shown in the figure, the signal switching circuit 9 comprises transistors TA, TB, respective emitter sides of which are parallel-connected to a constant current source Ir, and an output voltage from the time constant unit 8 is applied to the base of the transistor TA on one side while a reference voltage Vref is applied to the base of the transistor TB on the other side. Owing to such a configuration as described, if a voltage Va of an output signal SWCb from the time constant unit 8 is higher than the reference voltage Vref, the signal switching circuit 9 causes a current IB out of current from the constant current source Ir to flow to a side of the transistor TB more than to a side of the transistor TA, correspondingly to the voltage Va, and conversely, if the voltage Va is lower than the reference voltage Vref, a current IA is caused to flow to the side of the transistor TA more than to the side of the transistor TB.

Thus, the signal switching circuit 9 outputs the currents IA, IB, each undergoing a continuous change in current distribution ratio, due to magnitude of the voltage Va of the output signal, corresponding to rising and falling characteristics of the time constant unit 8. As shown in the figure, the currents IA, IB are each applied as a controlling current to the amplifiers 1, 2, respectively, so that the amplifiers 1, 2 generate outputs corresponding to respective amounts of the controlling currents, respectively. That is, respective amplification factors are altered in a range of 0 to 100% or in a range of 100 to 0% within a set time constant τ.

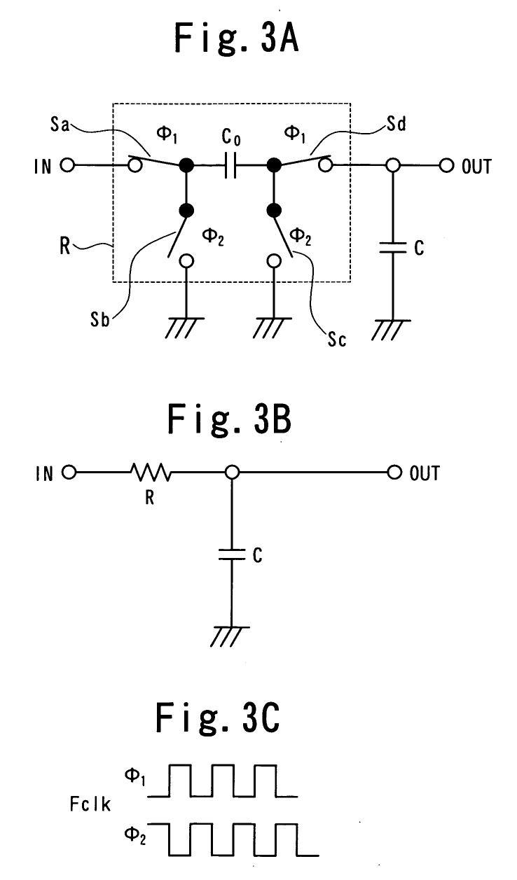

FIG. 3 is a view for specifically illustrating the time constant unit 8 described in the foregoing, in which FIG. 3A shows an actual time constant circuit using the SCF, and the time constant circuit has a configuration where switches Sa to Sd are provided on both sides of a capacitor C₀ so as to sandwich the capacitor C₀ between the respective switches Sa to Sd, and a capacitor C with one terminal grounded has the other terminal connected to the switch Sd. FIG. 3B shows an equivalent circuit of the time constant circuit, and the time constant τ of the equivalent circuit is represented by expression τ=RC. FIG. 3C shows switching signals Φ₁, Φ₂, for activating the switches Sa, Sb, respectively, and the switching signals Φ₁, Φ₂ each have the frequency Fclk.

With this configuration, upon alternate switchover among the respective switches Sa to Sd at the frequency Fclk, there occurs resistance, and a resistance value R thereof is represented by expression R=1/CFclk. Accordingly, if a period of the frequency Fclk at which the respective switches are switched over is lengthened, that is, if the frequency is lowered, this will enable resistance very large in the resistor R to be created in the IC. In this case, since the time constant τ is represented by expression τ=RC=(1/C₀Fclk)×C, if an R component, that is, 1/C₀Fclk, is considerably increased, this will enable capacitance of the conventional external capacitor C, having been on the order of several μF, to be rendered as small as, for example, on the order of several 10 pF, thereby enabling the capacitor C to be built inside the IC. Further, the time constant τ itself can be obviously enlarged.

Further, in the case where the time constant unit is made up of the SCF, since both the capacitor C₀, and the capacitor C are formed in the same layer of the IC of a multilayer structure, respective error tendencies of both the capacitors coincide with each other, and even in the case of respective capacitances of the capacitor C₀, and the capacitor C deviating from respective target values, respective errors are offset because the time constant is based on a ratio of the capacitance of the capacitor C₀ to that of the capacitor C, so that there is obtained an advantage of stability.

With the present embodiment, alteration of the frequency Fclk for the switchover of the respective switches, consequently alteration of the time constant τ, can be freely implemented by altering the frequency dividing rate directed by the controller 4a.

With the configuration described as above, selection of a volume level is executed by the respective switching circuits SW 1a′ to SW 2b′, and the signal switching circuit 9. Further, the signal switching circuit 9 is controlled by the time constant unit 8 so as to be gently switched over within the predetermined time (τ).

More specifically, when the volume level is switched over from the voltage level at the input terminal IN to the level of the voltage generated at the node between the resistors R1, R2, the setting data consisting of 8 bits, such as the volume, and so forth, sent from the system controller 15, is read into the controller 4a at predetermined timing by the serial data signal SDA, and the serial clock signal SCK to be subsequently latched at the timing of the data latch signal DL, thereby completing setting of the electronic volume circuit 12 as the sound signal selection means. The controller 4a first turns ON the switching circuit (SW 2a′) to be next selected according to the setting data, and further, turns OFF the switching circuit (SW 1a′) presently selected at predetermined timing, which, in this case, corresponds to a time when the switching circuit (SW 1b′) is further turned ON.

At the time of switchover of the respective switching circuits, the signal switching circuit 9 executes control such that the controlling current IA, or IB, being applied to the amplifier 1 or the amplifier 2, presently selected, respectively, is gradually decreased, and the controlling current IB, or IA, being applied to the amplifier 2 or the amplifier 1, respectively, is gradually increased instead. By so doing, a ratio of the output from the output terminal OUT is gradually switched over from the output of the amplifier 1 or the amplifier 2 to the output of the amplifier 2 or the amplifier 1, to be next selected, respectively. Thus, the output of the electronic volume circuit 12 will become only the output of either the amplifier 1 or the amplifier 2 after the elapse of time dependent on the time constant τ.

In the case of switchover from the switching circuit SW 2a′ to the switching circuit SW 1b′, and from the switching circuit SW 1b′ to the switching circuit SW 2b′, respectively, the same applies to switchover in output between the amplifiers 1, 2. Needless to say, an optional number of the switching circuits can be provided.

Thus, respective switches of the switching circuits SW 1a′, SW 2a′, SW 1b′, and SW 2b′ are sequentially switched over in that order, or in reverse order, thereby enabling switchover of the volume to be smoothly executed without causing an uncomfortable feeling and by use of a fewer number of the switches than the number of the switches in the conventional case.

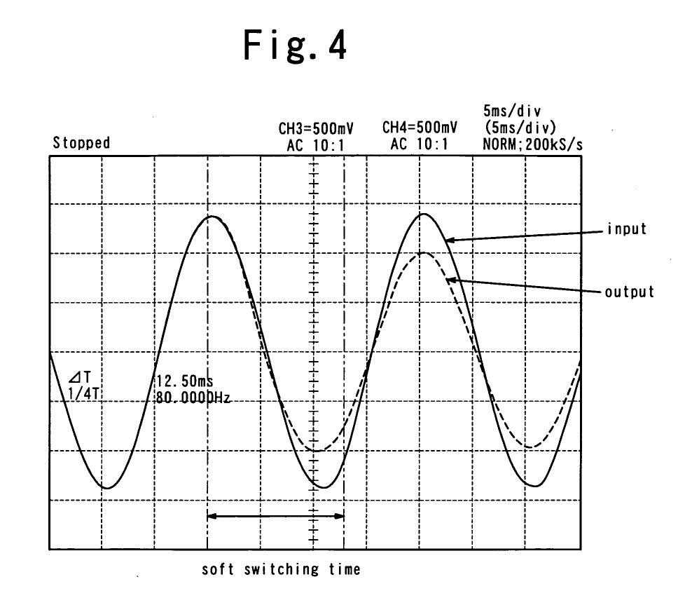

FIG. 4 is a waveform chart showing the switchover of the volume, according to the invention, by way of example. In the figure, there is shown a way in which an input signal indicated by a solid line is gradually switched over to an output signal indicated by a dotted line within switchover time according to the time constant as set by the time constant unit 8.

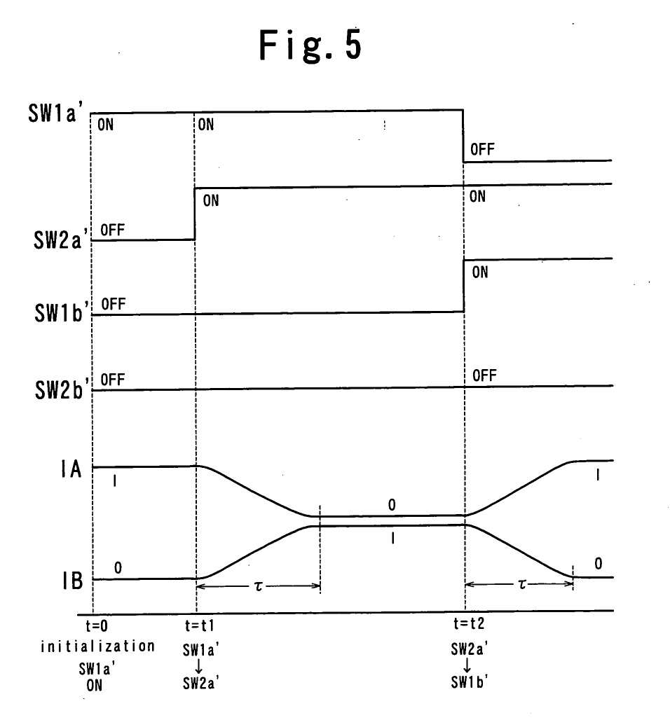

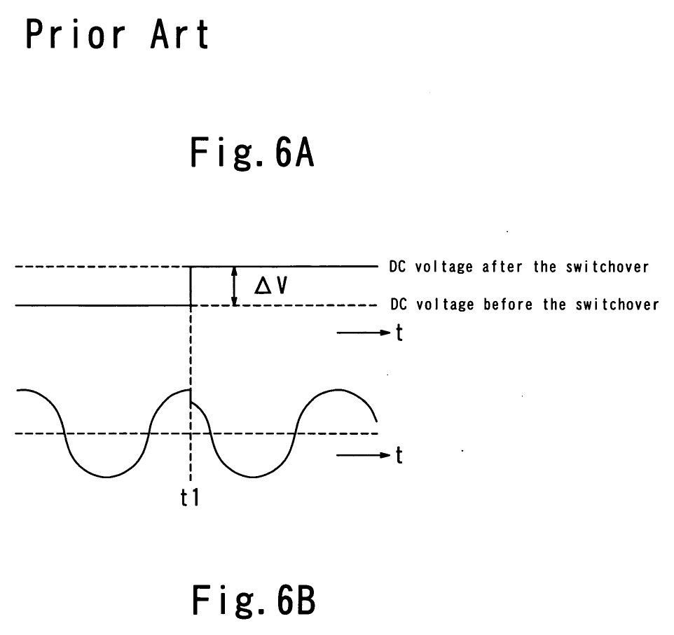

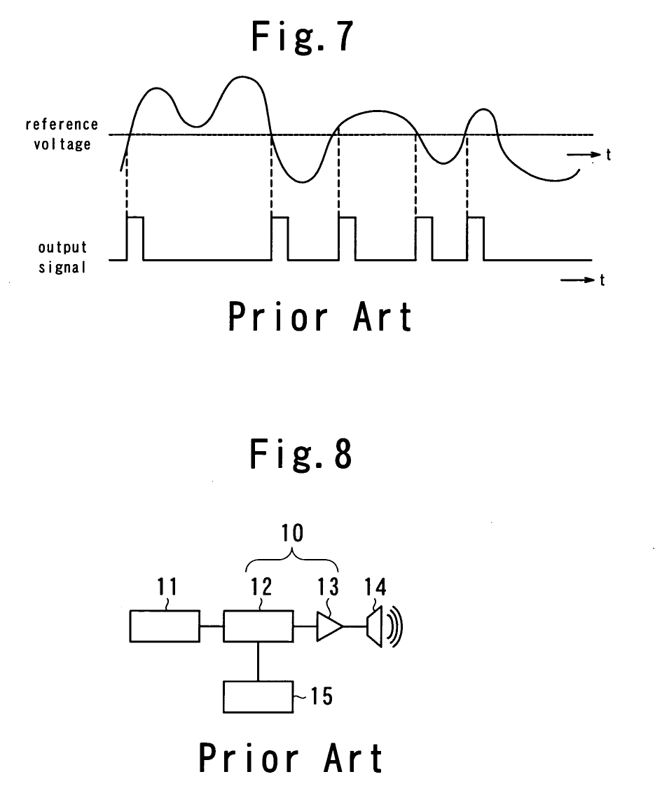

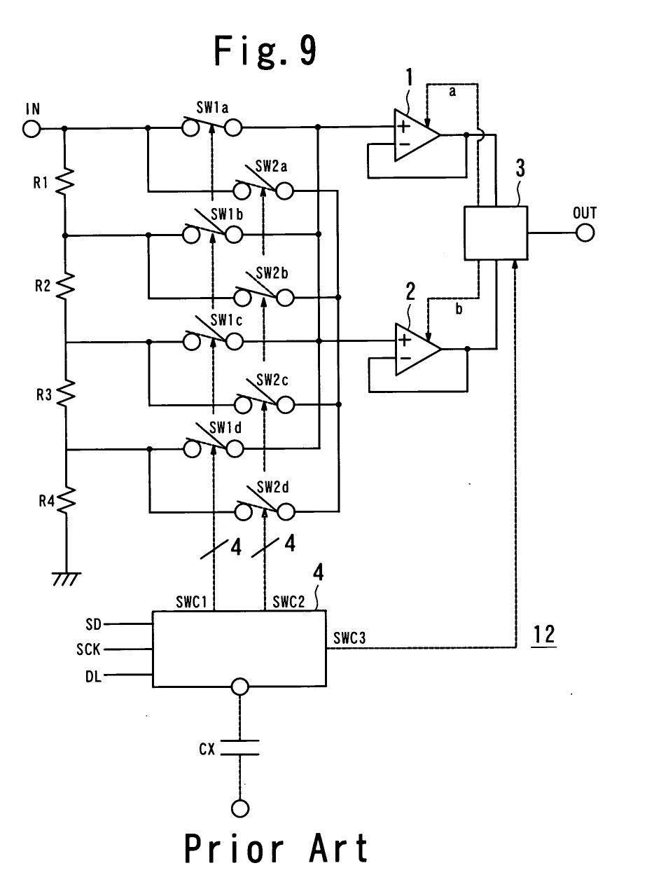

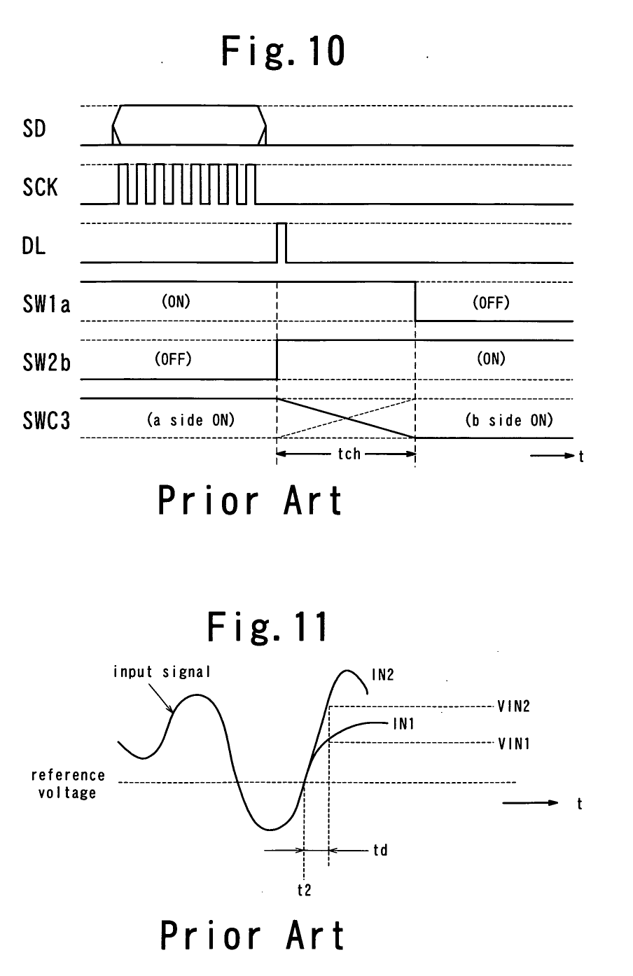

FIG. 5 is a view showing an example of a time chart for illustrating the switchover of the volume in the audio system according to the invention.

The switch SW 1a′ is in the ON condition at a present point in time (t=0), and thereafter, at a point in time (t=T₁) when the switch SW 2a′ is turned ON to switch over the volume, an output of the time constant unit 8 undergoes a change from Low (a condition A) to High (a condition B) following the ON condition of the switch SW 2a′, whereupon the controlling current IA from the signal switching circuit 9 undergoes a change from the maximum current Im (100%) toward 0 (0%), and conversely, the controlling current IB undergoes a change from 0 toward the maximum current Im. Subsequently, at a point in time (t=T₂) when the switch SW 1b′ is turned ON, the switch SW 1a′ is concurrently turned OFF, so that the voltage Va of the output signal from the time constant unit 8 undergoes a change, whereupon the controlling current IB from the signal switching circuit 9 undergoes a change from the maximum current Im (100%) toward 0 (0%), and conversely, the controlling current IA undergoes a change from 0 toward the maximum current Im.

Thus, the respective switching circuits SW 1a′ to SW 2b′ are sequentially switched over, thereby enabling the switchover of the volume to be smoothly executed.

The present invention adopting the above-described configuration has the following advantages:
(1) the number of the switches can be halved;
(2) there is no need for the capacitor installed outside the time constant unit as with the case of the conventional audio system; and
(3) because the time constant unit can be made up of the SCF installed internally, the frequency dividing rate for the frequency of the reference signal generated by the VCO is rendered variable, thereby enabling the frequency for the switchover of the respective switches, that is, the time constant τ, to be optionally set.

Further, the present invention is also applicable to a graphic equalizer for selecting input signals in respective frequency bands from a sound input source to be thereby amplified at optional amplification factors, respectively, so as to be combined together, before outputting, an input selector for simply selecting one of a plurality of input signals, and so forth. Still further, with the present embodiment of the invention, there is shown a case of volume setting by use of the electronic volume being made only in four steps, however, it is obvious that the number of setting steps may be set to an optional number according to the specification of a product.

1. An audio system comprising a sound input source including a microphone, and so forth, a sound output means including a speaker, and so forth, a sound signal selection means provided between the sound input source, and the sound output means, for switching over between sound signal propagation paths provided therebetween, on the basis of a control signal from a control means:
said sound signal selection means comprising a plurality of switching circuits provided so as to correspond to a plurality of sound signal output levels, respectively, and a signal switching circuit switchover means for turning ON the switching circuit corresponding to the sound signal output level to be selected on the basis of the control signal;
wherein at the time of switchover of respective sound signal, the signal switching circuit switchover means concurrently turns ON the switching circuit selected prior to the switchover, and the switching circuit to be selected after the switchover, and at the same time, gradually reducing a sound signal from the switching circuit selected prior to the switchover within time specified by a time constant of a time constant unit assembled inside an IC while gradually increasing a sound signal from the switching circuit to be selected after the switchover.

2. An audio system according to claim 1, wherein the time constant unit is made up of a switched capacitor filter circuit.

3. An audio system according to claim 1 or 2, further comprising a means for feeding a clock signal for controlling the time constant of the switched capacitor filter circuit, and a means for controlling a frequency of the clock signal.

4. An audio system according to claim 3, wherein the means for controlling the frequency of the clock signal is a controller for controlling a frequency dividing rate of a reference signal generated by a voltage-controlled oscillator.
